(19) United States
(12) Patent Application Publication
(10) Pub. No.: US 2026/0004951 A1
(43) Pub. Date: Jan. 1, 2026

(54) DATA COMMUNICATION LINE WITH LATTICE STRUCTURE

(71) Applicant: SAMTEC, INC., New Albany, IN (US)

(72) Inventors: Joseph Bryan SEGER, Jr., New Albany, IN (US); Michael Ryan MENKHAUS, New Albany, IN (US); Troy Benton HOLLAND, New Albany, IN (US)

(21) Appl. No.: 18/992,355

(22) PCT Filed: Jul. 7, 2023
(86) PCT No.: PCT/US2023/069761

§ 371 Date: Jan. 8, 2025

Related U.S. Application Data
(60) Provisional application No. 63/359,323, filed on Jul. 8, 2022.

(51) Int. Cl. H01B 11/00

(52) U.S. Cl. CPC H01B 11/002

(57) ABSTRACT

A data communication line can include a first segment, a second segment, and an electrically conductive element coupled to each of the first and second segments such that the first and second segments are movable relative to each other. The first and second segments can be electrically insulative. The first and second segments can be spaced from each other along a central axis of the data communication line. The first and second segments can be manufactured by an additive manufacturing process.

### CROSS-REFERENCE TO RELATED APPLICATIONS

This application claims the benefit of U.S. Provisional Application Ser. No. 63/359,323 filed Jul. 8, 2022, the contents of which is hereby incorporated by reference as if set forth in its entirety herein.

### TECHNICAL FIELD

The present disclosure relates generally to data communication lines, and more specifically to data communication lines that include a lattice structure.

### BACKGROUND

Electrical cables are used to connect one electrical component to another electrical component. Electrical cables typically include an electrical conductor surrounded by an electrical insulator. Coaxial cables include a center conductor surrounded by an insulation layer. Twinaxial cables are similar to coaxial cables, but contain two conductors instead of one. The two conductors of a twinaxial cable can be surrounded by an insulation layer. Typically, the insulation layers for each of the two center conductors of twinaxial cables are separately formed. A conductive shield covers the insulation layers.

Some data communication cables are manufactured by extruding the insulation layer onto a wire such that the insulation layer is a continuous element along the length of the cable. The resulting insulation layer has a single dielectric constant along the length of the cable. Therefore, a data communication line that does not need to be extruded and one that can have different dielectric constant along its length is desired.

### SUMMARY

A data communication line can include a first segment, a second segment, and an electrically conductive element coupled to each of the first and second segments such that the first and second segments are movable relative to each other. The first segment can be electrically insulative. The second segment can be electrically insulative. The first segment can be composed of a dielectric material. The second segment can be composed of a dielectric material. The first and second segment can be composed of the same material. The electrically conductive element can be elongate along a central axis.

The data communication line can include a second end and a first end spaced from the second end along the central axis. A shape of a first end of the first segment can correspond to a shape of the second end of the second segment. A first end of the first segment can include a recess. The recess can extend from the first end toward the second end along a recess axis. The recess axis can be parallel to the central axis. The first end of the first segment can include a concave shape in a plane perpendicular to the central axis. The second end of the second segment can include a protrusion. The protrusion can be configured to be positioned in the recess. The second end of the second segment can include a convex shape in a plane perpendicular to the central axis. The first end of the first segment can include a concave shape and the second end of the second segment can include a convex shape such that a portion of the second segment can be within the recess of the first segment. The concave portion of the first segment can be defined by a first arc having a first radius. The convex portion of the second segment can be defined by a second arc having a second radius. The first radius can be equal to the second radius. The first radius can be less than the second radius. The first radius can be greater than the second radius.

The first and second segments can be spaced from each other along the central axis. A portion of the second segment can be nested within a portion of the first segment without contacting the first segment. The first and second segments can be coupled to each other by a living hinge. The electrically conductive element can be a signal conductor. The first and second segments each comprise a porous three-dimensional structure. The first and second segments can include a plurality of struts defining unit cells. The first and second segments each include a plurality of unit cells. Respective groups of struts can intersect so as to define a respective plurality of nodes. In a further embodiment, the data communication line can include a plurality of pores defined by the unit cells, respectively. At least a portion of the first segment can overlap at least a portion of the second segment.

The electrically conductive element can be a first electrically conductive element and the data communication line can include a second electrically conductive element coupled each of the first and second segments. The first and second electrically conductive elements can be each elongate along a central axis of the data communication line. The first and second electrically conductive elements can be parallel to each other. The data communication line can be a twinaxial cable. The data communication line can be a coaxial cable.

The data communication line can be elongate along a central axis and the first segment can be rotatable relative to the second segment about the central axis. The data communication line can be movable from a first configuration wherein the data communication line is straight to a second configuration wherein the data communication line is curved. The first segment can be spaced from the second segment along the central axis when the data communication line is in the first configuration. The first segment can be in contact with the second segment when the data communication line is in the second configuration. The first segment can be movable along the central axis relative to the second segment. The first segment can be spaced from the second segment by a distance and the first segment can be movable relative to the second segment such that the distance is adjustable.

In a further embodiment, a signal cable includes at least two distinct electrically insulative segments and a signal conductor. The at least two distinct electrically insulative segments can be positioned immediately adjacent to one another and can move independently of one another. The signal conductor can pass through the at least two distinct electrically insulative segments.

In a further embodiment, a signal cable can include a signal conductor and a non-extruded dielectric material. In a further embodiment, a signal cable can include a signal conductor, and a non-foam lattice dielectric material. The non-foam lattice dielectric material can define at least two different cross-sectional shapes when cross sections are taken within approximately one millimeter of each other along a central axis of the non-foam lattice dielectric material.

In one embodiment, there is a non-extruded electrically insulative bead that can define a first end and an opposed second end. The first end can define a convex shape and the second end can define a concave shape.

A method of manufacturing a communication line can include fabricating a first segment and a second segment and coupling an electrically conductive element to each of the first and second segments such that the first and second segments are movable relative to each other. The electrically conductive element can be elongate along a central axis. The coupling step can include coupling the electrically conductive element to each of the first and second segments such that the first and second segments are spaced from each other along the central axis. Fabricating the first and second segments can include fabricating the first and second segments via additive manufacturing. Fabricating the first and second segments can include fabricating the first and second segments via three-dimensional printing. The coupling step can include inserting the electrically conductive element through each of the first and second segments. The first and second segments each include an opening and the coupling step can include inserting the electrically conductive element through the opening of each of the first and second segments.

In a further embodiment, the method includes selecting an impedance value for each of the first and second segments prior to the fabricating step. The fabricating step can include fabricating the first and second segments to have the selected impedance value. The method can include coupling a second electrically conductive element to each of the first and second segments.

The method can include selecting a threshold insertion loss value for the communication line prior to the fabricating step. The fabricating step can include fabricating the first and second segments such that a maximum insertion loss value of the communication line can be less than the threshold insertion loss value.

One embodiment of a data communication line can include a first segment, a second segment, and an electrically conductive element. The first segment can include a concave shape. The second segment can be positioned immediately adjacent to the first segment and include a convex shape that faces the concave shape. The electrically conductive element can pass through each of the first and second segments. The first and second segments can each be independently movable relative to each other.

One embodiment of a data communication line can include a first segment, a second segment, and an electrically conductive element. The first segment can be not pressure extruded, can be not insert molded, or both. The second segment can be not pressure extruded, can be not insert molded, or both and can be positioned immediately adjacent to the first segment. The electrically conductive element can pass through each of the first and second segments. The first segment, the second segment, or both can be made from a polymer, a curable polymer, or a photopolymer.

One embodiment of a data communication line can include a first segment, a second segment, and an electrically conductive element. The first segment can be a first electrically non-conductive segment that defines a first lattice structure. The second segment can be a second electrically non-conductive segment that defines a second lattice structure. The second electrically non-conductive segment can be positioned immediately adjacent to the first electrically non-conductive segment. The electrically conductive element can pass through each of the first and second electrically non-conductive segments. The first lattice structure and the second lattice structure can be the same.

One embodiment of a data communication line can include a first segment, a second segment, and an electrically conductive element. The first segment can be a first electrically non-conductive segment that defines a first lattice structure. The second segment can be a second electrically non-conductive segment that defines a second lattice structure. The second electrically non-conductive segment can be positioned immediately adjacent to the first electrically non-conductive segment. The electrically conductive element can pass through each of the first and second electrically non-conductive segments. The first electrically non-conductive segment and the second electrically non-conductive segment can physically abut one another but not be tethered or tied to one another except for the electrically conductive element. The first lattice structure and the second lattice structure can be the same.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 is a perspective view of a data communication line in accordance with one aspect of the present disclosure;

FIG. 2 is a side elevation view of one segment of the data communication line of FIG. 1;

FIG. 3 is a sectional view of the segment of FIG. 2;

FIG. 4 is a sectional view of the data communication line of FIG. 1;

FIG. 5 is a perspective view of the data communication line of FIG. 1 in a flexed position;

FIG. 6 is a side elevation view of the segment of FIG. 2 illustrating the structural details of the segment;

FIG. 7 is a sectional view of the segment of FIG. 6;

FIG. 8 is a top plan view of the segment of FIG. 6;

FIG. 9 is a bottom plan view of the segment of FIG. 6;

FIG. 10 is a perspective view of the segment of FIG. 6; and

FIG. 11 is a flow chart for a method of manufacturing the data communication line of FIG. 1.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Further, reference to a plurality as used in the specification including the appended claims includes the singular “a,” “an,” “one,” and “the,” and further includes “at least one.” Further still, reference to a particular numerical value in the specification including the appended claims includes at least that particular value, unless the context clearly dictates otherwise.

The term “plurality”, as used herein, means more than one. When a range of values is expressed, the range extends from the one particular value to the other particular value. Similarly, when values are expressed as approximations, by use of the antecedent “about,” it will be understood that the particular value forms another example. All ranges are inclusive and combinable.

The term “substantially,” “approximately,” and derivatives thereof, and words of similar import, when used to described sizes, shapes, spatial relationships, distances, directions, and other similar parameters includes the stated parameter in addition to a range up to 10% more and up to 10% less than the stated parameter, including up to 5% more and up to 5% less, including up to 3% more and up to 3% less, including up to 1% more and up to 1% less. If terms such as “equal”, “perpendicular”, or a numerical value associated with a given dimension are used to compare or describe elements of the invention, the terms should be interpreted as referring to within manufacturing tolerances.

Referring to FIG. 1, a data communication line 100 is depicted. The data communication line 100 can be a signal cable. The data communication line 100 can be a twinaxial cable. The data communication line 100 can be adapted to transmit a data communication signal from a first end 102 of the line 100 to a second end 104 of the line 100. The first end 102 can be spaced from the second end 104 along a central axis A₁. The first and second ends 102, 104 can be opposite each other in a longitudinal direction. The first end 102 can be configured to couple to a first electrical component. The second end can 104 can be configured to a second electrical component. At least one of the first and second electrical components can be an electrical connector, a housing, a circuit board, or an optical engine.

The data communication line 100 can include a conductive element 106. The conductive element 106 can be adapted to transmit a signal. The signal can be an electrical signal. The signal can be an optical signal. The conductive element 106 can be adapted to transmit the signal from the first end 102 to the second end 104. The conductive element 106 can be a signal conductor. The conductive element 106 can be an electrical signal conductor that is configured to carry electrical signals during operation. The conductive element 106 can be made from an electrically conductive material. The conductive element 106 can be manufactured from metal. The conductive element 106 can be manufactured from silver plated copper, bare copper, CuNi alloys, Cu alloys, Ag alloys, tin, tin alloys, gold plated copper, or any suitable alternative materials. The conductive element 106 can be a wire. The conductive element 106 can be a continuous element that extends the length of the data communication line 100. The conductive element 106 can extend along the central axis A₁ in an axial direction. It is recognized that the axial direction can be straight or curved, or can have straight sections and curved sections. The conductive element 106 can be bendable about an axis transverse to the central axis A₁.

In some embodiments, the data communication line 100 includes a single conductive element 106. In other embodiments, the data communication line includes a plurality of conductive elements. The data communication line 100 can include a first conductive element 108a and a second conductive element 108b. The first conductive element 108a can be positioned on a first side of the central axis A₁ and the second conductive element 108b can be positioned on a second side of the central axis A₁ opposite the first side. The first conductive element 108a can be parallel to the central axis A₁. The second conductive element 108b can be parallel to the central axis A₁. The first conductive element 108a and second conductive element 108b can be parallel to each other. The first conductive element 108a and second conductive element 108b can be parallel to each other such that the data communication line 100 is a twinaxial cable. The first conductive element 108a can surround the second conductive element 108b such that the data communication line 100 is a coaxial cable.

The data communication line 100 can include insulation 110 that envelops at least a portion of the conductive element 106. The insulation 110 entirely surrounds at least a majority of the length of the conductive element 106 with respect to a plane that is oriented perpendicular to the axial direction. The insulation 110 can be electrical insulation. The insulation 110 can be made from a dielectric material. The insulation 110 can be a non-foam dielectric material. The insulation 110 can be a non-foam lattice dielectric material. The insulation 110 can be a non-extruded material. The insulation 110 can be a non-extruded dielectric material. The insulation 110 can be porous. The insulation 110 can be a porous three-dimensional structure. The conductive element 106 can be disposed in the insulation 110. The insulation 110 can surround a majority of the length of the conductive element 106, such that a portion of the conductive element 106 extends axially out from the insulation 110 so as to establish an electrical connection with a complementary electrical component, such as an electrical connector, transceiver, printed circuit board, or alternative device.

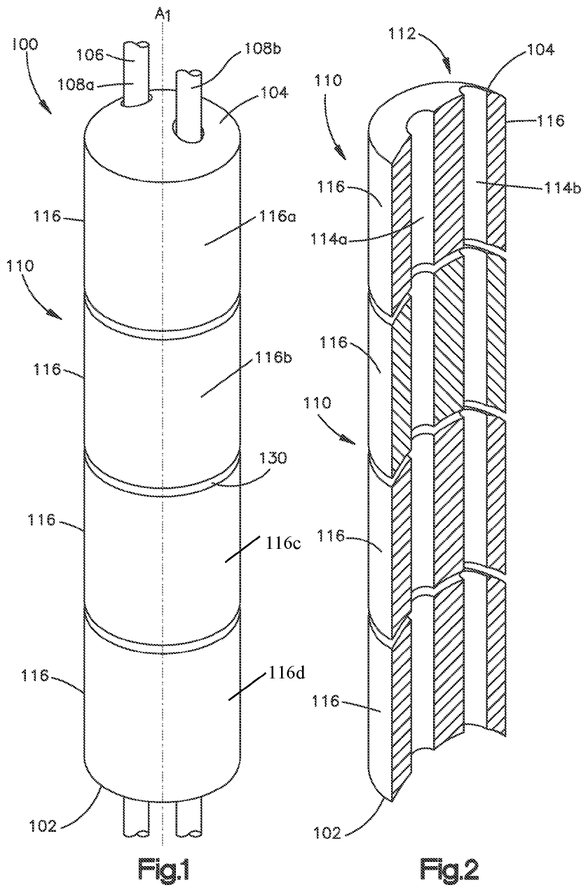

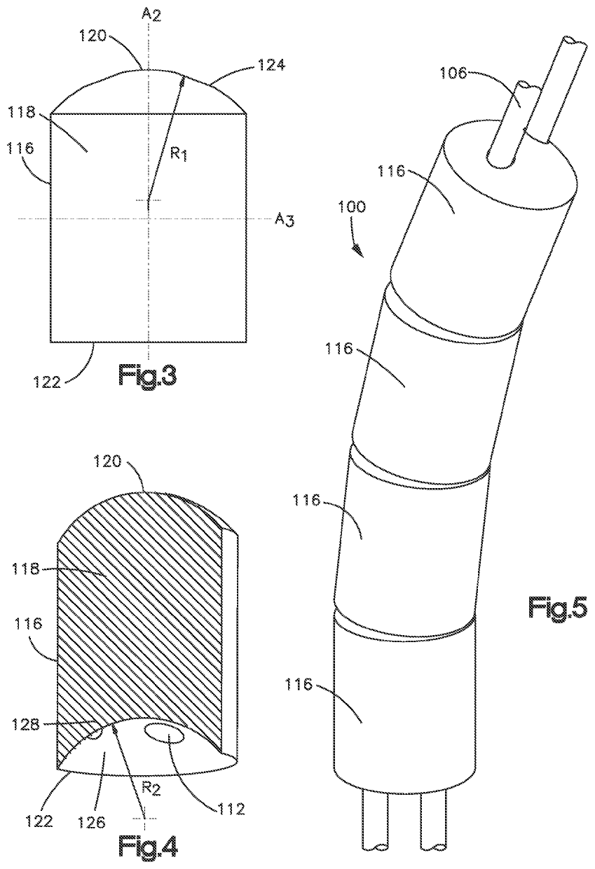

The insulation 110 can be adapted to receive the conductive element 106. Referring to FIG. 2, the insulation 110 can include a channel 112 sized and shaped to receive the conductive element 106. The channel 112 can extend the length of the insulation 110 from the first end 102 to the second end 104. The channel 112 can include a first channel 114a and a second channel 114b to receive the first conductive element 108a and the second conductive element 108b, respectively. In other embodiments, the insulation 110 does not include a channel and the conductive element 106 is inserted through the insulation to create the channel.

In some embodiments, the insulation 110 is a continuous element that extends a majority of the length of the data communication line 100. In other embodiments, the insulation 110 can include a plurality of segments 116. For example, the insulation 110 can include first, second, third, and fourth segments 116a, 116b, 116c, and 116d. The plurality of segments 116 can be manufactured without pressure extrusion, without insert molding, or without both. The conductive element 106 can be coupled to each of the segments 116. The conductive element 106 can pass through each segment 116. The conductive element 106 can couple the segments 116 together. The segments 116 can be spaced from each other along the central axis A₁. The segments 116 can be equally spaced from each other along the length of the conductive element 106. In some embodiments, the segments 116 are spaced from each other along the central axis A₁ such that the segments 116 do not contact each other. In other embodiments, the segments 116 are connected by a living hinge.

The segments 116 can each include a central axis A₂ (FIG. 3). The central axis A₂ of each segment 116 can be parallel to central axis A₁. The central axis A₂ of some segments 116 can be parallel to central axis A₁. The central axis A₂ of each segment 116 can be coaxial with central axis A₁. The central axis A₂ of some segments 116 can be coaxial with central axis A₁. Each segment 116 can include a lateral axis A₃ (FIG. 4). The lateral axis A₃ can be perpendicular to the central axis A₂.

Each segment 116 can be a distinct segment 116 separate from the other segments 116. Each segment 116 can be movable relative to at least one other segment 116. Each segment 116 can be independently movable relative to the other segments 116. At least one segment 116 can be movable relative to at least one other segment along central axis A₁. At least one segment 116 can be rotatable about the central axis A₁ relative to the other segments 116. Each segment 116 can be rotatable about the central axis A₁ relative to the other segments 116. In some examples, at least one segment 116 can be spaced from an adjacent segment by a gap 130. The segments 116 can be movable relative to each other along central axis A₁ such that the height of the gap 130 along axis A₁ is adjustable.

Referring to FIGS. 3 and 4, the segment 116 can include a body 118. The body 118 can include a second end 120 and a first end 122 spaced from the second end 120 along the central axis A₂. The segment 116 can include a height as measured from the second end 120 to the first end 122. In some examples, each of the segments are of equal height. In other examples, the height of the first segment 116a can be less than a height of the second segment 116b. The height of each segment 116 can be less than a majority of the length of the data communication line 100.

The body 118 can have a width as measured along lateral axis A₃ from a first lateral edge to a second lateral edge. In some examples, each of the segments are of equal width. In other examples, the width of the first segment 116a can be less than a width of the second segment 116b. The second end 120 can have a width as measured along an axis parallel to lateral axis A₃ that is smaller than the width of the body 118. The second end 120 can define a convex shape. In other examples, the second end 120 defines a flat or concave shape. The second end 120 can define a hemispherical shape. The second end 120 can define a semispherical shape. The convex shape of the second end 120 can be defined by an arc 124 having a first radius R₁. In some examples, the second end 120 includes a continuous radius across the arc 124. In other examples, the second end 120 can be defined by more than one radii across the arc 124. The second end 120 can have an oval cross-sectional shape. The second end 120 can define a protrusion. The second end 120 can define a protrusion having a square, triangular, or rectangular profile shape when viewed in a plane including central axis A₂ and lateral axis A₃.

The first end 122 of the segment 116 can include a surface 126 that defines a recess. The first end 122 can be concave. In other examples, the first end 122 defines a flat or convex shape. The concave portion can be defined by an arc 18 having a radius R₂. Radius R₁ can be equal to radius R₂. Radius R₁ can be less than radius R₂. Radius R₁ can be greater than radius R₂. The recess can have a square, triangular, or rectangular cross-sectional shape in a plane including central axis A₂ and lateral axis A₃. The shape of the recess can be complementary to the shape of the protrusion at the second end 120. The segment 116 can be an insulative bead that defines a first end and an opposed second end. The first end can define a convex shape and the second end can define a concave shape.

It may be desirable for the electrical insulation value to change along the length of the data communication line 100. The physical properties of each segment 116 can be selected so as to tune the impedance or reduce insertion loss along the length of the data communication line 100. For example, the first and second segments 116a, 116b can have different shapes such that the first and second segments 116a, 116b have different electrical insulation values. The first and second segments 116a, 116b can be manufactured from different materials such that the first and second segments 116a, 116b have different electrical insulation values.

The first segment 116a can be immediately adjacent the second segment 116b along the central axis A₁. At least a portion of the second segment 116b can be nested within the first segment 116a. A portion of the second segment 116b can be nested within the first segment 116a while the first segment 116a and second segment 116b are spaced from each other along the central axis A₁. A portion of the second segment 116b can be nested within the first segment 116a while the first segment 116a and second segment 116b without contacting the first segment 116a. The first segment 116a can abut the second segment 116b. The first segment 116a can abut the second segment 116b but the first segment 116a can be not tethered or tied to the second segment 116b except for the electrically conductive element 106. In some examples, the conductive element 106 is the only physical connection between the first and second segments 116a, 116b.

A shape of the first end 122 of the first segment 116a can correspond to the shape of the second end 120 of the second segment 116b. A shape of the first end 122 of the first segment 116a can be complementary to the shape of the second end 120 of the second segment 116b. A shape of the first end 122 of the first segment 116a can be an inverse of the shape of the second end 120 of the second segment 116b. A portion of the second end 120 of the second segment 116b can be within the first end 122 of the first segment 116a. At least a portion of the first segment 116a can overlap a portion of the second segment 116b. The first segment 116a can be spaced from the second segment 116b and overlap a portion of the second segment 116 such that the conductive element 106 is not externally visible. The data communication line 100 can be movable from a first configuration (FIG. 1) to a second configuration (FIG. 5). The first end 122 of the first segment 116a may be spaced from the second end 120 of the second segment 116b when the data communication line is in a second configuration. The surface 126 of the first segment 116a can be in contact with the second end 120 of the second segment 116b. The surface 126 of the first segment 116a can abut the second end 120 of the second segment 116b. An outer wall of each of the first and second segments 116a, 116b can be spaced from each other such that the outer walls define the gap 130 while the surface 126 and the second end 120 are in contact with each other. The surface 126 and the second end 120 of the first and second segments 116a, 116b can remain in contact with each other as the data communication line transitions from the first configuration to the second configuration. The size of the gap 130 between the outer walls of the first and second segments 116a, 116b can be non-uniform when the data communication line is in the second configuration. The first segment 116a may contact the second segment 116b to provide a minimum radius of curvature for the data communication line 100. The minimum radius of curvature can be selected to prevent plastic deformation of the conductive element 106. The first and second ends 120, 122 nested within each other can allow the data communication line to have a greater radius of curvature in the second configuration than traditional cables with a single piece insulation jacket.

The data communication line 100 can be substantially straight in the first configuration. The data communication line 100 can be curved in the second configuration. At least one segment 116 can be rotatable about a lateral axis relative to the other segments 116. Each segment 116 can be rotatable about the lateral axis relative to the other segments 116. Rotation of at least one segment 116 about the lateral axis relative to another segment 116 can transition the data communication line 100 from the first configuration to the second configuration. In some examples, the segments 116 are in contact with adjacent segments 116 when the data communication line 100 is in the first configuration. In other examples, the segments 116 can be spaced from each other along the central axis A₁ such that the segments 116 do not contact each other when the data communication line 100 is in the first configuration. At least some of the segments 116 can contact each other when the data communication line 100 is in the second configuration. At least some of the segments 116 that are immediately adjacent each other can contact each other when the data communication line 100 is in the second configuration.

The segments 116 can be made from a polymer, a curable polymer, or a photopolymer. The segments 116 can be made from a polymer, a curable polymer, or a photopolymer. The segments can be non-conductive. The segments 116 can be electrically non-conductive. The first segment 116a can be electrically non-conductive and can define a first lattice structure. The second segment 116b can be electrically non-conductive and can define a second lattice structure. The first and second lattice structures can be the same. The first and second segments 116a, 116b can be positioned immediately adjacent one another. The first and second segments can physically abut one another and not be tethered or tied to one another except for the electrically conductive element 106. The first segment 116a can include a concave shape. The second segment can include a convex shape that faces the concave shape. The first and second segments 116a, 116b can be independently movable relative to each other.

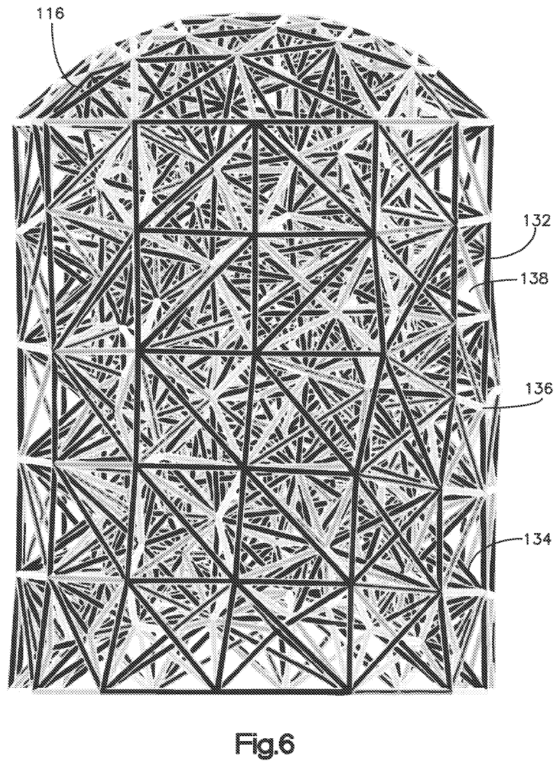

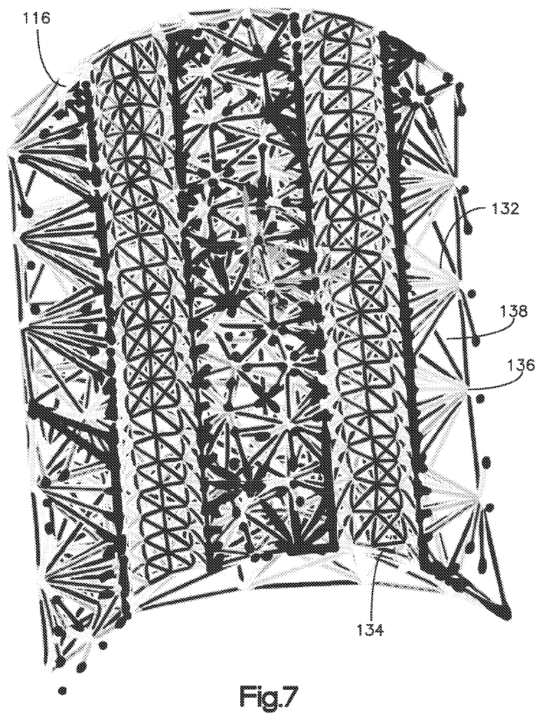

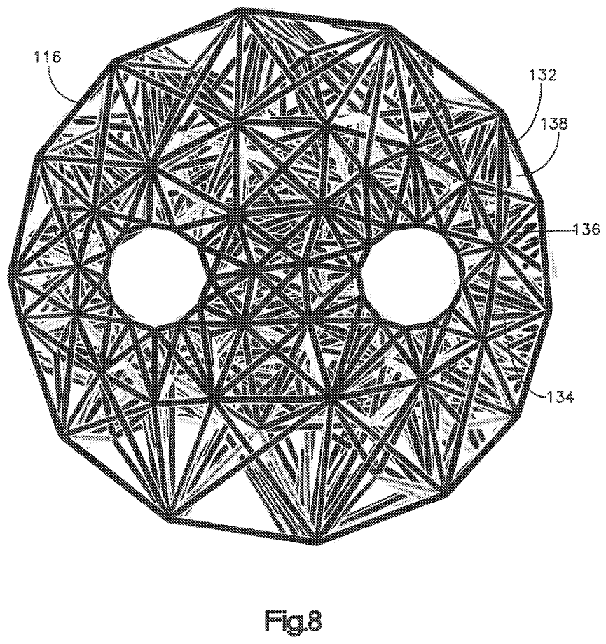

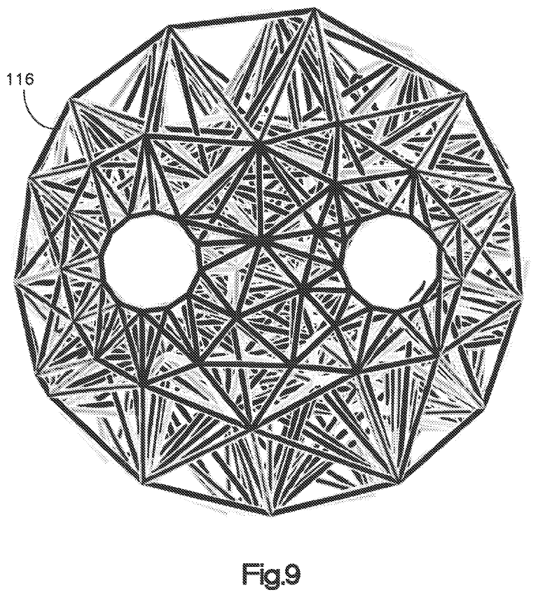

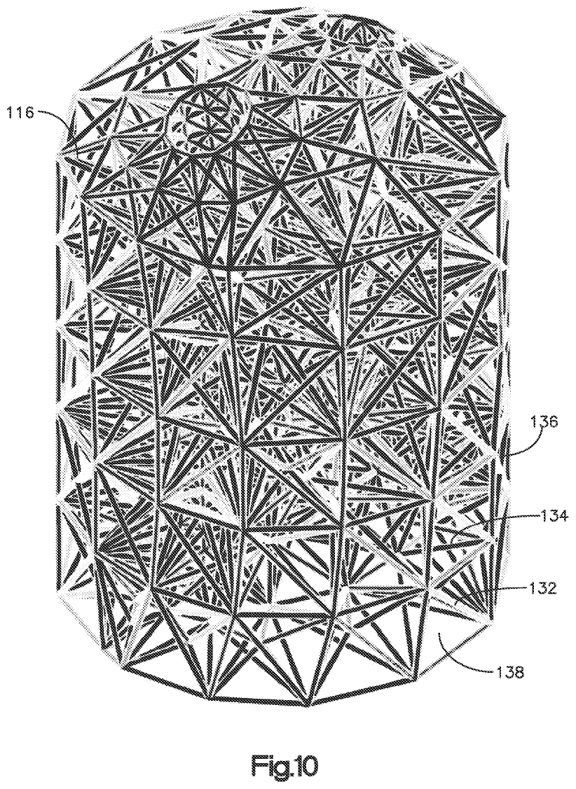

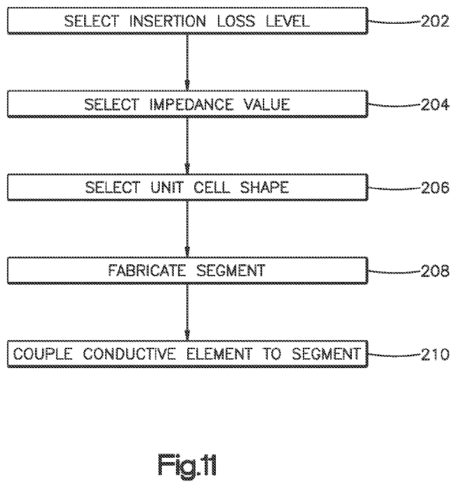

Referring to FIGS. 6-10, the segment 116 can include a plurality of struts 132 that define a unit cell 134. The segment 116 includes a three-dimensional lattice structure defined by a plurality of the unit cells 134. The unit cell 134 can have a tetrahedron shape. The struts 132 can intersect so as to define a plurality of nodes 136. The struts 132 can each have a length as measured between the nodes 136. The unit cells 134 can define a plurality of pores 138. The length and thickness of the struts 132 can influence the size of the pores 138. For example, a unit cell with shorter, thicker struts will result in smaller pores than a unit cell with longer, thinner struts. The segment 116 can have a uniform porosity throughout the body 118 of the segment 116. The segment 116 can have at least two different cross-sectional shapes when a cross-section perpendicular to central axis A₂ is taken at different locations along central axis A₂. The cross-section locations can be at about 1 millimeter apart from each other along the central axis A₂.

Each segment 116 can be manufactured from the same material. Alternatively, at least one segment 116 can be manufactured from a material different than the material of at least one other segment 116. Each segment 116 can be manufactured from the same mixture of materials. Alternatively, at least one segment 116 can be manufactured from a material mixture different than the material mixture of at least one other segment 116. Each segment 116 can be manufactured from the same mixture of materials in the same ratio. Alternatively, at least one segment 116 can be manufactured from a material mixture with at least one material at a different ratio than the material mixture of at least one other segment 116.

Referring to FIG. 11, a method of manufacturing the data communication line 100 can include selecting an insertion loss value for the data communication line 100 at step 202. The insertion loss value can be a threshold value that the data communication line 100 is not to exceed. The selected insertion loss value can influence design parameters for the data communication line 100. For example, a ratio of the cross-sectional surface area of the conductive element 106 relative to the segment 116 can be influenced by the selected insertion loss value.

The method can include selecting an impedance value at step 204. The impedance value of the segment 116 can be selected based on intended use of the data communication line 100. The selected impedance value can influence design parameters such as manufacturing material for the insulation. The size and shape of the segment 116 and segments 116 can also be influenced by the selected impedance value.

The method can include selecting the shape of the unit cell 134 at step 206. One or more of step 202, step 204, and step 206 can be performed prior to fabricating the segment 116. Each of step 202, 204, and step 206 can be performed prior to fabricating the segment 116.

The method can include fabricating the segment 116 at step 208. Fabricating the segment 116 can include fabricating the segment 116 via additive manufacturing. Fabricating the segment 116 can include fabricating the segment 116 via three-dimensional printing. The fabricating step 208 can include depositing and bonding successive layers of material to each other. The bonding can be achieved with a beam. The beam (or scanning beam) can be an electron beam. The beam (or scanning beam) can be a laser beam. The material can be a powder. The powder can be sintered to form the three-dimensional lattice structure. The fabricating step 208 can include forming the struts 132 that define the three-dimensional lattice structure of the segments 116. In some embodiments, the fabricating step 208 includes forming the channel 112 in the segments. In other embodiments, the fabricating step 208 does not include forming the channel 112. The fabricating step 208 can include fabricating the segments to have the selected impedance value. The fabricating step 208 can include fabricating the segments 116 such that a maximum insertion loss value of the communication line 100 is less than the threshold insertion loss value.

The method can include coupling the conductive element 106 to the segment 116 at step 210. The method can include coupling the conductive element 106 to the segment after the segment 116 has been fabricated. The method can include inserting the conductive element 106 into the channel 112 of the segment 116. The method can include moving the segment 116 relative to the conductive element 106 along the central axis A₁. The method can include coupling the first segment 116a and second segment 116b to the conductive element 106 such that the first segment 116a is spaced from the second segment 116b along the central axis A₁. The method can include inserting the conductive element 106 through the segment 116. The segment 116 may not initially include a channel 112 and the method may include inserting the conductive element 106 through the segment 116 thereby forming the channel 112. The method may include inserting the first conductive element 108a and the second conductive element 108b through the segment 116. The method may include sequentially inserting the first conductive element 108a through the segment 116 and then inserting the second conductive element 108b through the segment 116. The method may include simultaneously inserting the first conductive element 108a through the segment 116 and then inserting the second conductive element 108b through the segment 116.

Certain terminology is used in the description for convenience only and is not limiting. The words “axial,” “vertical,” “transverse,” “left,” “right,” “above,” “below,” “longitudinal,” “transverse,” and “rotational” designate directions in the drawings to which reference is made. The term “substantially” is intended to mean considerable in extent or largely but not necessarily wholly that which is specified. The terminology includes the above-listed words, derivatives thereof and words of similar import.

The term “plurality,” as used herein, means more than one. The singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure. Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

1. A data communication line comprising:
a first segment;
a second segment; and
an electrically conductive element coupled to each of the first and second segments such that the first and second segments are movable relative to each other.

2. The data communication line of claim 1, wherein the first segment is electrically insulative.

3. The data communication line of claim 1, wherein the second segment is electrically insulative.

4. The data communication line of claim 1, wherein the first segment and the second segment are composed of a dielectric material.

5. The data communication line of claim 1, wherein the first segment and the second segment are physically separable from one another.

6. (canceled)

7. The data communication line of claim 1, wherein the electrically conductive element is elongate along a central axis.

8. The data communication line of claim 7, wherein the data communication line includes a second end and a first end spaced from the second end along the central axis.

9. The data communication line of claim 8, wherein a shape of a first end of the first segment corresponds to a shape of the second end of the second segment.

10. The data communication line of claim 9, wherein the first end of the first segment includes a recess.

11. The data communication line of claim 10, wherein the recess extends from the first end toward the second end along a recess axis.

12. The data communication line of claim 11, wherein the recess axis is parallel to the central axis.

13. (canceled)

14. The data communication line of claim 10, wherein the second end of the second segment includes a protrusion.

15. The data communication line of claim 14, wherein the protrusion is configured to be positioned in the recess.

16. (canceled)

17. The data communication line of claim 10, wherein the first end of the first segment includes a concave shape and the second end of the second segment includes a convex shape such that a portion of the second segment is within the recess of the first segment.

18. (canceled)

19. (canceled)

20. (canceled)

21. (canceled)

22. (canceled)

23. The data communication line of claim 1, wherein the first and second segments are coupled to each other by a living hinge.

24. The data communication line of claim 1, wherein the electrically conductive element is a signal conductor.

25. The data communication line of claim 1 wherein the first and second segments each comprise a porous three-dimensional structure.

26. The data communication line of claim 1, wherein the first and second segments include a plurality of struts defining unit cells.

27. (canceled)

28. (canceled)

29. (canceled)

30. (canceled)

31. The data communication line of claim 1, wherein the electrically conductive element is a first electrically conductive element and the data communication line further comprises a second electrically conductive element coupled each of the first and second segments.

32. (canceled)

33. (canceled)

34. The data communication line of claim 1, wherein the data communication line is a twinaxial cable.

35. The data communication line of claim 1, wherein the data communication line is a coaxial cable.

36. (canceled)

37. The data communication line of claim 7, wherein the data communication line is movable from a first configuration wherein the data communication line is straight to a second configuration wherein the data communication line is curved.

38. The data communication line of claim 37, wherein the first segment is spaced from the second segment along the central axis when the data communication line is in the first configuration, and
wherein the first segment is in contact with the second segment when the data communication line is in the second configuration.

39. The data communication line of claim 7, wherein the first segment is movable along the central axis relative to the second segment.

40. The data communication line of claim 1, wherein the first segment is spaced from the second segment by a distance and the first segment is movable relative to the second segment such that the distance is adjustable.

41.-59. (canceled)
